(19) United States
(12) Patent Application Publication
(10) Pub. No.: US 2003/0225574 A1
(43) Pub. Date: Dec. 4, 2003

(54) Encoding and transmission method and apparatus for enabling voiceband data signals to be transmitted transparently in high-efficiency encoded voice transmission system

(76) Inventors: Hirokazu Matsuura, Kawasaki (JP); Kazuya Uno, Kawasaki (JP); Ryo Nonomura, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/342,737

(22) Filed: Jan. 15, 2003

(30) Foreign Application Priority Data
May 28, 2002 (JP) 2002-154127 PAT.

(51) Int. Cl. G10L 21/00

(52) U.S. Cl. 704/212

(57) ABSTRACT

The invention enables FAX signals to be transmitted transparently in a CDMA-WLL system. Data of many FAX signal waveforms are prestored in a vocoder in a terminal, and when a FAX signal is input, the index value of the waveform data having the smallest difference relative to the input signal is transmitted out.

### BACKGROUND OF THE INVENTION

1. Field of the Invention

The present invention relates to an encoding and transmission method, and an apparatus, for enabling voiceband data signals to be transmitted transparently in a high-efficiency encoded voice transmission system, and more particularly to an encoding and transmission method, and an apparatus, suited to transparent transmission of analog facsimile signals in a CDMA (Code Division Multiple Access)—WLL (Wireless Local Loop) system.

2. Description of the Related Art

CDMA-WLL systems are known that can accommodate subscriber terminals by using the facilities of a CDMA mobile telephone system and without physically laying telephone lines to the subscriber premises. In such CDMA-WLL systems, as in conventional CDMA systems, voice is high-efficiency encoded by a vocoder and transmitted over a wireless link.

In a system, such as a CDMA-WLL system, designed to transmit voice high-efficiency encoded by a vocoder, if a voiceband data signal such as a G3-FAX signal is transmitted, there arises the problem that the original signal cannot be completely restored at the receiving end, because the original analog waveform cannot be completely restored at the time of demodulation.

Therefore, in the prior art, it has been practiced to equip the terminal with a FAX modem for FAX signal input as well as a vocoder for voice input and to transmit the FAX signal to the base station after converting it into the original digital data by the FAX modem; at the network side, it has been practiced to convert the digital data back to the FAX signal at the entrance to the exchange network.

In this way, the terminal has had to be equipped with a FAX modem, while at the network side, large-scale IWF (Inter Working Function) equipment has had to be provided to reconvert the digital data to the FAX signal, and complex control such as communication path switching procedures (protocols) for switching between a voice call and a FAX call has had to be performed in the base station controller.

### SUMMARY OF THE INVENTION

It is, accordingly, an object of the present invention to provide an encoding and transmission method, and an apparatus, which are simple in configuration and suited to transparent transmission of voiceband data signals such as facsimile signals in a CDMA-WLL or like system designed to transmit high-efficiency encoded voice.

According to the present invention, there is provided an encoding method comprising the steps of: high-efficiency encoding an input signal as a voice signal; selecting a waveform closest to the waveform of the input signal from among a plurality of prestored waveforms; selecting either the result of the high-efficiency encoding or the result of the waveform selection in accordance with a predetermined criterion; and outputting an identifier indicating the selected waveform, in place of the result of the high-efficiency encoding, when the result of the waveform selection is selected.

According to the present invention, there is also provided a transmission method comprising the steps of: high-efficiency encoding an input signal as a voice signal; selecting a waveform closest to the waveform of the input signal from among a plurality of prestored waveforms; selecting either the result of the high-efficiency encoding or the result of the waveform selection in accordance with a predetermined criterion; transmitting an identifier indicating the selected waveform, in place of the result of the high-efficiency encoding, when the result of the waveform selection is selected; and reconstructing the input signal from the transmitted result of the high-efficiency encoding or the transmitted identifier.

According to the present invention, there is also provided an encoding apparatus comprising: means for high-efficiency encoding an input signal as a voice signal; means for selecting a waveform closest to the waveform of the input signal from among a plurality of prestored waveforms; means for selecting either the result of the high-efficiency encoding or the result of the waveform selection in accordance with a predetermined criterion; and means for outputting an identifier indicating the selected waveform, in place of the result of the high-efficiency encoding, when the result of the waveform selection is selected.

According to the present invention, there is also provided a transmission system comprising: means for high-efficiency encoding an input signal as a voice signal; means for selecting a waveform closest to the waveform of the input signal from among a plurality of prestored waveforms; means for selecting either the result of the high-efficiency encoding or the result of the waveform selection in accordance with a predetermined criterion; means for transmitting an identifier indicating the selected waveform, in place of the result of the high-efficiency encoding, when the result of the waveform selection is selected; and means for reconstructing the input signal from the transmitted result of the high-efficiency encoding or the transmitted identifier.

### BRIEF DESCRIPTION OF THE DRAWINGS

FIG. 1 is a block diagram showing the configuration of a prior art CDMA-WLL system;

FIG. 2 is a simplified block diagram showing the configuration of a terminal 12;

FIG. 3 is a simplified block diagram showing the configuration-of a terminal 12′ according to one embodiment of the present invention; and

FIG. 4 is a simplified block diagram showing the configuration of vocoder 32′.

### DESCRIPTION OF THE PREFERRED EMBODIMENTS

A description will be given below by taking a CDMA-WLL system as an example of the high-efficiency encoded voice transmission system and a G3-FAX signal as an example of the voiceband data signal, but it will be appreciated that the present invention is not limited to these specific examples.

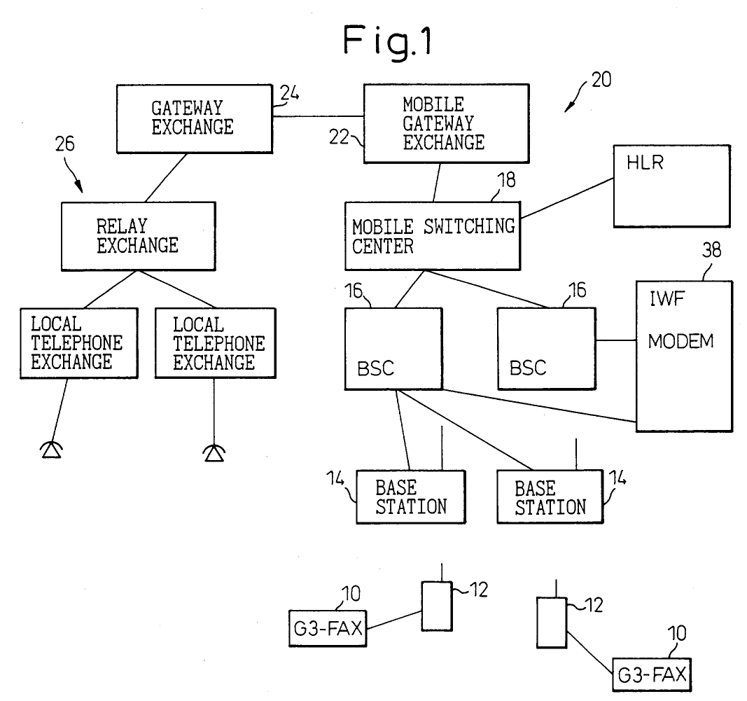

FIG. 1 shows one example of the configuration of a prior art CDMA-WLL system that can transmit G3-FAX signals. A subscriber terminal 12 to which a G3-FAX machine 10 is attached is connected to a base station 14 via a wireless link (CDMA). A plurality of base stations 14 are connected to a base station controller (BSC) 16, and a plurality of BSCs 16 are centrally connected to a mobile switching center 18. A mobile communication network 20 comprising these elements is connected to a public telephone exchange network 26 via a mobile gateway exchange 22 and a gateway exchange 24.

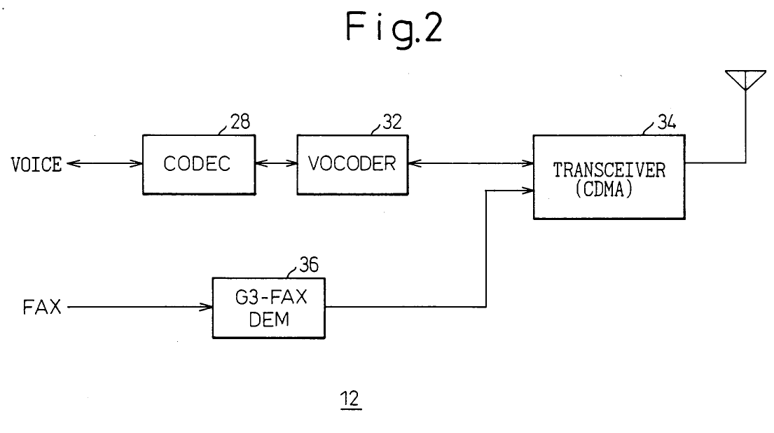

FIG. 2 is a simplified block diagram showing the configuration of the terminal 12. As shown in FIG. 2, voice is converted by a codec 28 into a digital signal (PCM conversion) which, after being high-efficiency encoded by a vocoder 30, is transmitted from a transceiver 34 toward the base station 14. On the other hand, a G3-FAX signal is converted by a FAX modem 36 into the original digital signal for transmission to the base station 14.

Turning back to FIG. 1, the base station controller 16 discriminates between a voice call and a FAX call and, in the case of a FAX call, the signal is converted back into the G3-FAX signal (the PCM converted version of the G3-FAX signal) by a FAX modem in IWF equipment 38, and transmitted to the mobile exchange 18. In the case of a voice call, the voice signal (the PCM converted version of voice) is reconstructed by a vocoder in the base station controller 16, and transmitted to the mobile switching center 18.

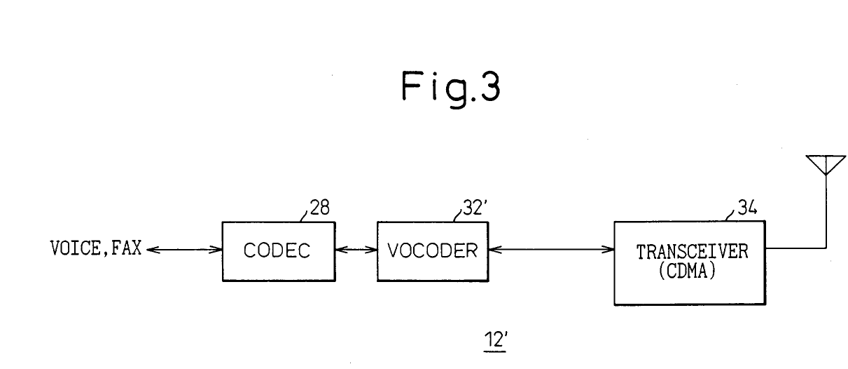

FIG. 3 shows the configuration of a terminal 12′ according to one embodiment of the present invention. In the present invention, the FAX signal, as well as voice, is first PCM converted by the codec 28, and then encoded by a vocoder 32′.

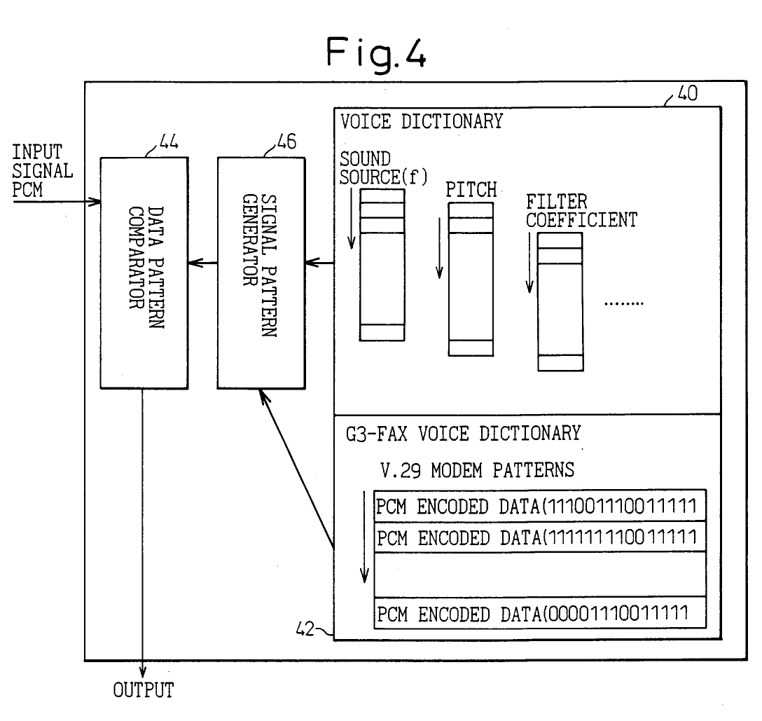

FIG. 4 is a diagram conceptually showing the configuration of the vocoder 32′ according to the one embodiment of the present invention. In FIG. 4, a voice dictionary section 40, similarly to the one provided in the conventional vocoder, takes an input signal as voice, for example, at intervals of 20 msec, and searches sound source indexes, pitches, and filter coefficients using, for example, CELP (Code Excited Linear Predicting) techniques and outputs a set of parameters that can reproduce the waveform closest to the input waveform. A G3-FAX voice dictionary section 42 stores various waveform patterns of G3-FAX signals (V.29 waveform patterns, V.34 waveform patterns, etc.) in PCM format. These includes CNG tone (1100 Hz) and CED tone (2100 Hz).

A signal pattern generator 46 outputs voice by reproducing it from the parameters determined by the voice dictionary section 40, and also outputs waveform data by sequentially retrieving them from the G3-FAX voice dictionary section 42. A data pattern comparator 44 compares the input signal with these waveform data, and determines the data that has the smallest difference. If this difference is smaller than the difference between the input signal and the signal reproduced from the above parameters, an output indicating that the input is FAX data is produced, while determining the type of modem and the index value of the waveform pattern. Conversely, if the difference relative to the waveform reproduced from the parameters is smaller, the above parameters are set for output. Instead of switching between voice and FAX based on the result of the comparison between the differences as described above, the switching may be made, for example, in accordance with an external control signal.

In this way, when the input is voice, a bit indicating that the input is voice and the sound source index value, pitch value, and filter coefficients are transmitted from the terminal 12 to the base station 14 at intervals of 20 msec; on the other hand, when the input is a FAX signal, a bit (one bit) indicating that the input is a FAX signal, bits (for example, eight bits) indicating the type of modem, the index value (for example, 32 bits) of the waveform pattern, and Os as fill bits to fill up the remainder are transmitted out.

The vocoder in the base station controller 16 stores PCM data of various FAX waveform patterns, as in the vocoder in the terminal, and when the code received from the terminal is a FAX signal, the base station controller 16 transmits the PCM value of the waveform data corresponding to the index value to the mobile exchange 18.

The above encoding process can be implemented using software for the computer built in the terminal 12.

Compared with the prior art CDMA-WLL system shown in FIG. 1, the CDMA-WLL system according to the above embodiment of the present invention offers the following advantages.

(1) When constructing the CDMA system, the need for IWF equipment (modem) which was essential to the construction of the prior art system can be eliminated. As IWF equipment which usually occupies one rack can be eliminated, a signification cost reduction can be achieved.

(2) As there is no need to mount a G3-FAX modem chip in other equipment than the FAX machine, the subscriber terminal can be further reduced in size and reduced in cost because of a reduced number of parts.

(3) As the number of times that FAX data is modulated and demodulated is reduced, the error rate of transmitted data decreases, and the throughput improves.

1. An encoding method comprising the steps of:
(a) high-efficiency encoding an input signal as a voice signal;
(b) selecting a waveform closest to the waveform of said input signal from among a plurality of prestored waveforms;
(c) selecting either the result of said high-efficiency encoding or the result of said waveform selection in accordance with a predetermined criterion; and
(d) outputting an identifier indicating said selected waveform, in place of the result of said high-efficiency encoding, when the result of said waveform selection is selected.

2. A method according to claim 1, wherein said step (c) includes the step of selecting the result of said waveform selection when the difference between said selected waveform and the waveform of said input signal is smaller than the difference between said input signal and voice reproduced from the result of said high-efficiency encoding.

3. A method according to claim 1, wherein said plurality of prestored waveforms are waveforms of analog facsimile signals.

4. A transmission method comprising the steps of:
(a) high-efficiency encoding an input signal as a voice signal;
(b) selecting a waveform closest to the waveform of said input signal from among a plurality of prestored waveforms;
(c) selecting either the result of said high-efficiency encoding or the result of said waveform selection in accordance with a predetermined criterion; and
(d) transmitting an identifier indicating said selected waveform, in place of the result of said high-efficiency encoding, when the result of said waveform selection is selected, and
(e) reconstructing said input signal from the transmitted result of said high-efficiency encoding or the transmitted identifier.

5. A method according to claim 4, wherein said step (c) includes the step of selecting the result of said waveform selection when the difference between said selected waveform and the waveform of said input signal is smaller than the difference between said input signal and voice reproduced from the result of said high-efficiency encoding.

6. A method according to claim 4, wherein said plurality of prestored waveforms are waveforms of analog facsimile signals.

7. An encoding apparatus comprising:
means for high-efficiency encoding an input signal as a voice signal;
means for selecting a waveform closest to the waveform of said input signal from among a plurality of prestored waveforms;
means for selecting either the result of said high-efficiency encoding or the result of said waveform selection in accordance with a predetermined criterion; and
means for outputting an identifier indicating said selected waveform, in place of the result of said high-efficiency encoding, when the result of said waveform selection is selected.

8. An apparatus according to claim 7, wherein said result selecting means selects the result of said waveform selection when the difference between said selected waveform and the waveform of said input signal is smaller than the difference between said input signal and voice reproduced from the result of said high-efficiency encoding.

9. An apparatus according to claim 7, wherein said plurality of prestored waveforms are waveforms of analog facsimile signals.

10. A transmission system comprising:
means for high-efficiency encoding an input signal as a voice signal;
means for selecting a waveform closest to the waveform of said input signal from among a plurality of prestored waveforms;
means for selecting either the result of said high-efficiency encoding or the result of said waveform selection in accordance with a predetermined criterion;
means for transmitting an identifier indicating said selected waveform, in place of the result of said high-efficiency encoding, when the result of said waveform selection is selected; and
means for reconstructing said input signal from the transmitted result of said high-efficiency encoding or the transmitted identifier.

11. A system according to claim 10, wherein said result selecting means selects the result of said waveform selection when the difference between said selected waveform and the waveform of said input signal is smaller than the difference between said input signal and voice reproduced from the result of said high-efficiency encoding.

12. A system according to claim 10, wherein said plurality of prestored waveforms are waveforms of analog facsimile signals.
